(19) United States
(12) Patent Application Publication
(10) Pub. No.: US 2015/0152949 A1
(43) Pub. Date: Jun. 4, 2015

(54) PILOTING SLEEVE FOR CENTERING TRANSMISSION INPUT SHAFT

(71) Applicant: Schaeffler Technologies GmbH & Co. KG, Herzogenaurach (DE)

(72) Inventors: David Avins, Burbank, OH (US); Patrick Lindemann, Wooster, OH (US)

(73) Assignee: Schaeffler Technologies GmbH & Co. KG, Herzogenaurach (DE)

(21) Appl. No.: 14/546,125

(22) Filed: Nov. 18, 2014

Related U.S. Application Data
(60) Provisional application No. 61/911,511, filed on Dec. 4, 2013.

(51) Int. Cl. F16H 41/24; F16D 1/06

(52) U.S. Cl. CPC F16H 41/24; F16D 1/06

(57) ABSTRACT

A piloting sleeve for a torque converter comprising: (i) an axis of rotation; (ii) a tubular body portion including a circumferential wall comprising: a first inner circumferential surface having a first inner diameter; a second inner circumferential surface having a second inner diameter; a first outer circumferential surface having a first outer diameter; (iii) an extended portion including at least two castles, each including a tip portion, for attachment to a cover; and (iv) a distal end. A transmission assembly comprising: a transmission input shaft and a torque converter including the piloting sleeve as described.

### FIELD

The invention relates generally to a torque converter with a feature for centering an input shaft for a transmission with an engine driving the torque converter.

### BACKGROUND

U.S. Patent Publication No. 2013/0233665, hereby incorporated by reference herein, describes a particular configuration for centering an input shaft on a piston plate, which is in turn centered on an L-shaped centering flange fixed to the cover.

U.S. Pat. No. 7,150,148, hereby incorporated by reference herein, describes an input shaft centered in a converter pilot.

U.S. Patent Publication No. 2009/0032351, hereby incorporated by reference herein, teaches concepts with input shafts centered by sheet metal components fixed to the cover.

U.S. Patent Publication No. 2009/0013682, hereby incorporated by reference herein, teaches an input shaft centered by a piston plate and hub, where the piston plate is a twin plate piston connected to the cover by leaf springs.

U.S. Patent Publication No. 2013/0233664, hereby incorporated by reference herein, teaches a centering flange fixedly attached to a cover for centering an input shaft without the use of an output hub.

### BRIEF SUMMARY

Example aspects broadly comprise a piloting sleeve for a torque converter comprising: an axis of rotation; a tubular body portion including a circumferential wall comprising: a first inner circumferential surface having a first inner diameter; a second inner circumferential surface having a second inner diameter; a first outer circumferential surface having a first outer diameter; an extended portion including at least two castles, each including a tip portion, for attachment to a cover; and a distal end.

Other example aspects broadly comprise a piloting sleeve where the at least two castles include: an outer slant portion; an inner slant portion; and at least one side wall portion.

Other example aspects broadly comprise a piloting sleeve where the tip portion is flat, rounded, or pointed.

Other example aspects broadly comprise a piloting sleeve where the extended portion is formed by cold heading.

Other example aspects broadly comprise a piloting sleeve where the first inner diameter is at most equal to the second inner diameter.

Other example aspects broadly comprise a piloting sleeve where the second inner circumferential surface includes a recess portion for receiving a bushing.

Other example aspects broadly comprise a piloting sleeve having a circumferential groove that extends radially inward from the first outer circumferential surface and includes a second outer circumferential surface having a second outer diameter.

Other example aspects broadly comprise a torque converter comprising: a cover; a piloting sleeve as described above fixedly attached to the cover; a piston plate; a seal disposed in the groove for sealing engagement with the piloting sleeve and the piston plate; and a bushing for positioning a transmission input shaft.

Other example aspects broadly comprise a torque converter where the tip portion is flat, rounded, or pointed.

Other example aspects broadly comprise a torque converter where the extended portion is formed by cold heading.

Other example aspects broadly comprise a torque converter where the first inner diameter is at most equal to the second inner diameter.

Other example aspects broadly comprise a torque converter further comprising a cover pilot, wherein the second inner circumferential surface of the piloting sleeve includes a recess portion for receiving the bushing, and wherein an outer surface of the cover pilot is concentric relative to the recess portion.

Other example aspects broadly comprise a torque converter where the tip portions of the piloting sleeve are attached to the cover by projection welding.

Other example aspects broadly comprise a transmission assembly comprising: a transmission input shaft; and the torque converter as described above.

Other example aspects broadly comprise a transmission assembly where the transmission input shaft is centered by the piloting sleeve with respect to the cover.

Other example aspects broadly comprise a transmission assembly as described above where a centering plate is fixedly attached to the piston plate and centers the piston plate with respect to the transmission input shaft.

Other example aspects broadly comprise a torque converter comprising: a cover; a piloting sleeve, fixedly attached to the cover, comprising: a base tubular portion; an extended portion including at least two castles, each having a tip portion; and an external annular sealing groove; a piston plate; a seal disposed in the annular sealing groove for sealing engagement with the piloting sleeve and the piston plate; and a bushing for positioning a transmission input shaft.

Other example aspects broadly comprise a method for installing a torque converter onto a transmission assembly comprising the steps of: providing a piloting sleeve as described above; projection welding the tip portions of the piloting sleeve to a torque converter cover; affixing a cover pilot having an outer surface to the cover; machining the piloting sleeve and the cover pilot outer surface to be concentric with one another; and pressing a bushing into the inner diameter of the tube for centering of a transmission input shaft.

Other example aspects broadly comprise a method as described above further comprising the step of supporting and piloting the transmission input shaft with the bushing.

Other example aspects broadly comprise a method as described above further comprising the step of fixedly attaching a centering plate to the piston plate and centering the piston plate with respect to the transmission input shaft.

### BRIEF DESCRIPTION OF THE DRAWINGS

The nature and mode of operation of the present invention will now be more fully described in the following detailed description of the invention taken with the accompanying drawing figures, in which:

FIG. 1 illustrates a partial cross-sectional view of a torque converter according to an example aspect;

FIG. 2 illustrates a cross-sectional side view of a piloting sleeve according to an example aspect;

FIG. 3 illustrates a front view of a piloting sleeve according to an example aspect; and

FIG. 4 illustrates a perspective view of a piloting sleeve according to an example aspect.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

A piloting sleeve for piloting or centering a torque converter relative to a transmission input shaft is disclosed. The piloting sleeve may also be referred to interchangeably herein as a centering sleeve, a centering tube, a piloting tube, or the like. The piloting sleeve can be formed by any conventional production method such as stamping, cutting, drawing, cold forming, and flow forming, for example. Desirable results have been achieved by forming the piloting sleeve using a flow formed or cold formed method and forming the extended portion, including features such as “castles” or “protrusions”by cold forging or stamping. The use of cold forming can concentrate the material where it is needed for strength, while also providing desired shape characteristics.

For cold formed parts, improved stiffness is experienced over stampings, and the process can create various material thicknesses in different locations on the components. Therefore, it can minimize overall mass while concentrating material in critical areas, such as in the castles in an example aspect. Furthermore, tooling is comparable to that for powdered metal and far less expensive and complex than that required for stamping. The level of detail achievable in cold forming is good enough that many applications require no additional machining.

A cold-headed tube design that is projection welded to a torque converter cover for centering of a transmission input shaft is disclosed. The tube, or piloting sleeve, includes a machined area for receiving a bushing for centering the input shaft and a groove to receive a seal for sealing the piloting sleeve to the piston plate. The configuration also optionally includes a piston centering plate for centering the piston plate relative to the input shaft. Extended projection weld protrusions or castles allow flow between the cover and hub.

Castles are upwardly extending projections cold formed to a base tube. The castles, along with additional material to elongate the base tube during cold forming, are also referred to as the extended portion. The castles or projections define ‘through slots’ or openings through which fluid flow may freely pass. The spaces or gaps between castles or protrusions formed on the piloting sleeve are advantageously arranged for attachment to the cover to be circumferentially offset. In an example aspect, castles are evenly spaced apart.

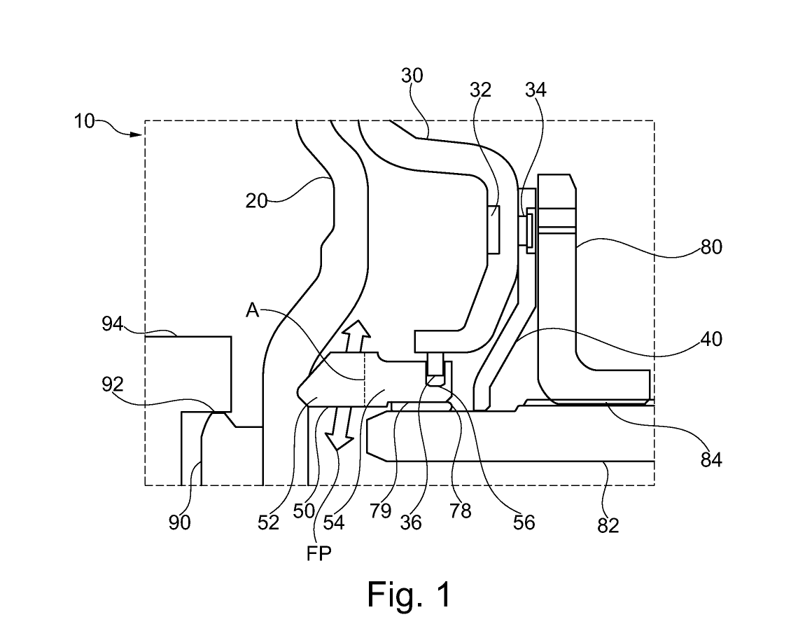

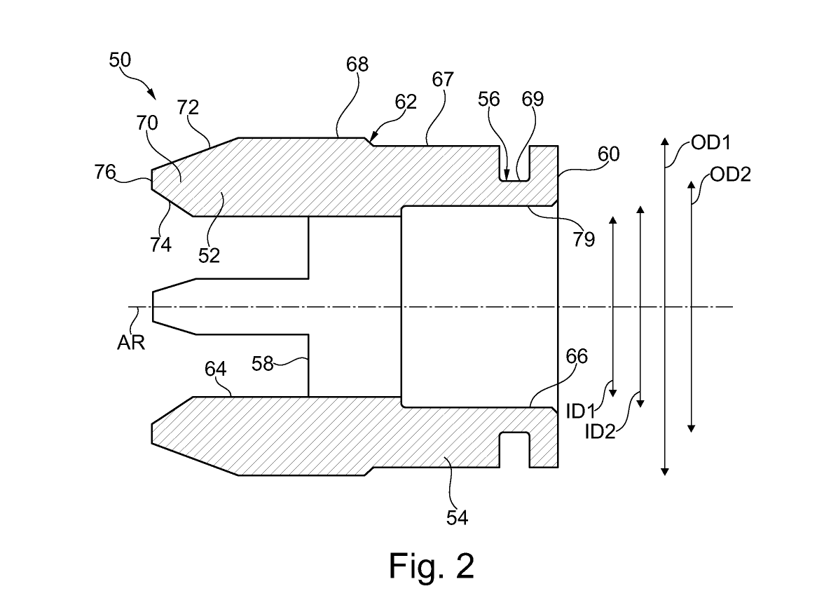

The following description is made with reference to FIGS. 1-4. FIG. 1 is a partial cross-sectional view of a torque converter with piloting sleeve according to an example aspect. Torque converter 10 comprises cover 20, piston plate 30, seal 36, centering plate 40, and piloting sleeve 50. Piloting sleeve 50 includes extended portion 52 and base portion 54. Extended portion 52 is delineated from base portion 54 by line A for schematic purposes only. Piloting sleeve 50 is one monolithic piece in total. In an example aspect, extended portion 52 is formed by cold heading or cold forming techniques as are known in the art. Extended portion 52 includes castles, as will be described in FIG. 2; wherein castles 70 define through slots 58, which may be interchangeably referred to as bores, holes, or openings herein, through which fluid flow may pass as indicated by the arrows FP for fluid path in FIG. 1.

Piloting sleeve 50 further includes groove 56. Groove 56 is arranged to receive seal 36, which is an example aspect is a dynamic seal. Seal 36 is a teflon seal in an example aspect; alternatively, seal 36 is an o-ring. Piloting sleeve 50 is machined to include a recess portion, as will be described in FIG. 2, to receive bushing 78. Piston 30 includes a displaced piston portion 32, which is displaced to form extruded rivet 34. Further, FIG. 1 illustrates centering plate 40, flange 80, transmission input shaft 82, and cover pilot 90. Cover pilot 90 includes outer surface 92, which is positioned by crank shaft 94. Flange 80 is engaged to transmission input shaft 82 by spline 84.

FIG. 2 illustrates a longitudinal cross-section of piloting sleeve 50 comprising axis of rotation AR, extended portion 52, base portion 54, groove 56, through slots 58, and distal end 60. Piloting sleeve 50 further comprises tubular wall or circumferential wall 62, interchangeably referred to herein as tubular body portion or base tubular portion; wherein circumferential wall 62 includes first inner circumferential surface 64 having first inner diameter ID1, second inner circumferential surface 66 having second inner diameter ID2, and first outer circumferential surface 68 having first outer diameter OD1. In an example aspect, first inner diameter ID1 is at most equal to second inner diameter ID2. In other words, in an example aspect, piloting sleeve 50 is internally machined to provide a second inner circumferential surface 66 having a second inner diameter ID2 equal to or greater than first inner diameter ID1. In a non-limiting example, machined second inner circumferential surface 66 includes recess portion 79 for receiving bushing 78 (of FIG. 1).

Extended portion 52 includes at least two castles 70 having outer slant 72, inner slant 74, and tip portion 76. Circumferential wall 62 includes annular or circumferential groove 56 extending radially inward from first outer circumferential surface 68 to include second outer circumferential surface 69 having second outer diameter OD2. In an example aspect, first outer diameter OD1 is greater than second outer diameter OD2. First outer circumferential surface 68 is also machineable and, as shown, includes third outer circumferential surface 67, which includes a diameter at most equal to diameter OD1 and is at least equal to diameter OD2.

Through slots 58 defined by castles 70 allow for fluid to freely pass. Castles 70 are advantageously arranged alternatively with through slots 58 for attachment to cover 20 (of FIG. 1) to be circumferentially offset. In an example aspect, castles 70 are evenly spaced apart. Piloting sleeve 50 includes at least two castles 70. In another example aspect, three castles are included. In a preferred example aspect, piloting sleeve 50 includes four castles 70 alternatively with four through slots 58; however, as one skilled in the art appreciates, piloting sleeve 50 may include any number of castles 70 for attachment to cover 20 providing that structural integrity is not sacrificed.

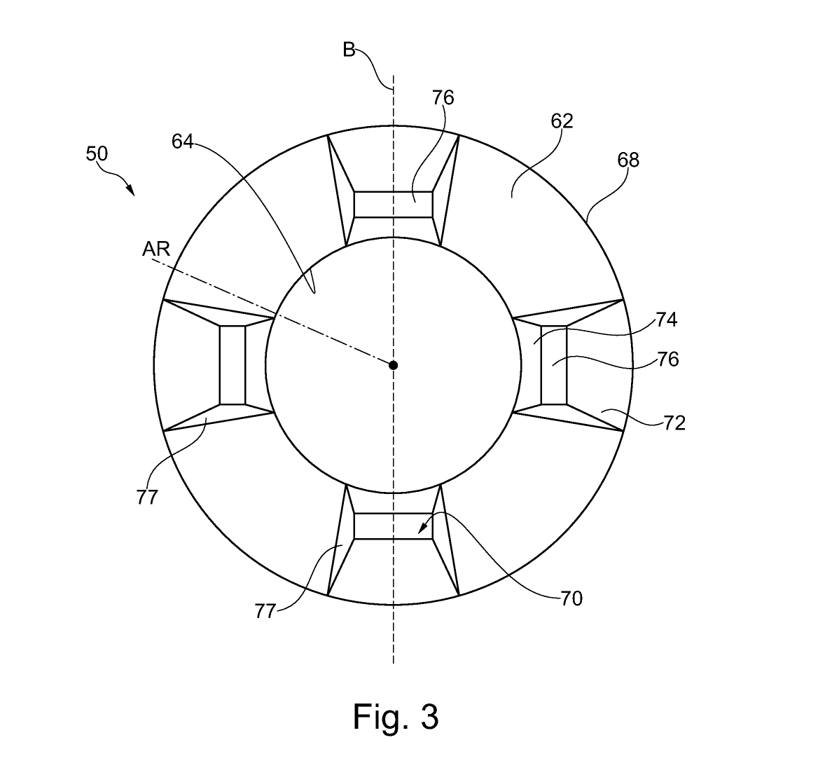

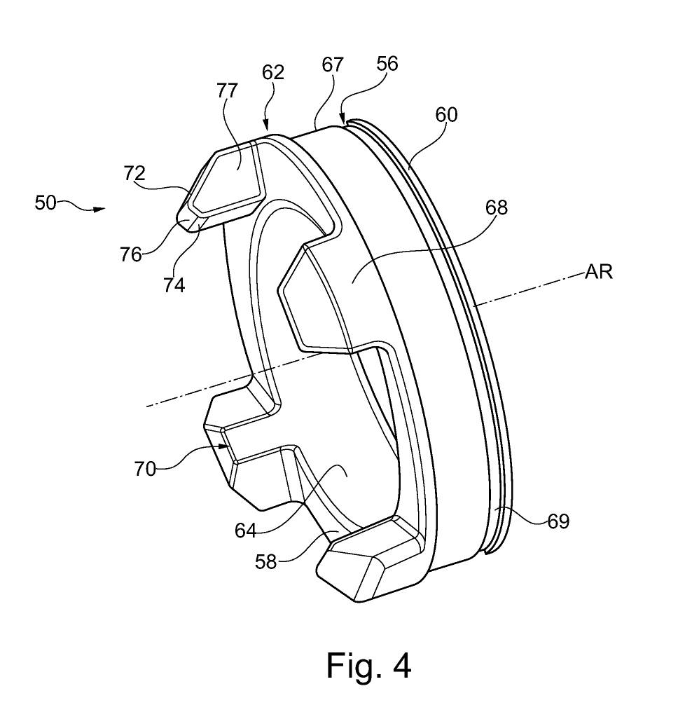

FIG. 3 shows a front view of piloting sleeve 50. Piloting sleeve 50 includes circumferential wall 62, castles 70, line of symmetry B, and axis of rotation AR. Circumferential wall 62 includes first inner circumferential surface 64 and first outer circumferential surface 68. Castles 70 include outer slants 72, inner slants 74, tip portions 76, and at least one side wall 77. Tip portions 76 may be flat, pointed, rounded, or any suitable shape for attachment to cover 20. In an example aspect, attachment of castles 70 to cover 20 is achieved by projection welding. Attachment surface (not shown) is defined as the portion of piloting sleeve 50, fixed to or attached to cover 20, and includes at least tip portions 76 of castles 70. FIG. 4 is a three-dimensional perspective view of piloting sleeve 50 according to an example aspect.

In an example aspect, torque converter 10 comprises cover 20, piloting sleeve 50 fixedly attached to the cover, piston plate 30, seal 36 disposed in groove 56 for sealing engagement with piloting sleeve 50 and piston plate 30; and a bushing for positioning transmission input shaft 82. An attachment surface or portion is formed at the intersection of piloting sleeve 50 and cover 20, which includes at least tip portions 76. Extended portion 52, in an example aspect, is formed by cold heading. Torque converter 10 includes piloting sleeve 50 including first inner diameter ID1 and second inner diameter ID2, wherein ID1 is at most equal to ID2.

In an example aspect, torque converter 10 includes cover pilot 90 attached to cover 20. Advantageously, outer surface 92 of cover pilot 90 and recess portion 79 are concentrically disposed relative to one another providing for centering or alignment, wherein bushing 78 positions transmission input shaft 82. Second inner circumferential surface 66 of piloting sleeve 50 includes recess portion 79. Tip portions 76 of piloting sleeve 50 are attached to cover 20 by projection welding. In an example aspect, torque converter 10 includes transmission input shaft 82 centered by piloting sleeve 50 with respect to cover 20. In another example aspect, torque converter 10 includes centering plate 40 fixedly attached to piston plate 30 and centers piston plate 30 with respect to transmission input shaft 82.

A transmission assembly, according to an example aspect, comprises transmission input shaft 82 and torque converter 10, where torque converter 10 comprises: cover 20 and piloting sleeve 50, fixedly attached to cover 20. Piloting sleeve 50 includes base tubular portion or circumferential wall 62; extended portion 52 including at least two castles 70, each having tip portion 76; and external annular sealing groove 56. Torque converter 10 further comprises piston plate 30; seal 36 disposed in annular sealing groove 56 for sealing engagement with piloting sleeve 50 and piston plate 30; and bushing 78 for positioning transmission input shaft 82.

A method for installing a torque converter onto a transmission is as follows. Although the method is presented in a sequence for clarity, no order should be inferred from the sequence unless explicitly stated. The method comprises the steps of: (i) providing piloting sleeve 50 as described herein; (ii) projection welding tip portions 76 of piloting sleeve 50 to torque converter cover 20 to form an attachment surface; (iii) affixing cover pilot 90 to cover 20; (iv) machining piloting sleeve 50 and outer surface 92 of cover pilot 90 to be concentric with one another; and (v) pressing bushing 78 into the second inner diameter ID2 of tube or circumferential wall 62 for centering of transmission input shaft 82.

According to another example aspect, the method further comprises the step of supporting and piloting transmission input shaft 82 with bushing 78. According to another example aspect, the method further comprises the step of fixedly attaching centering plate 40 to piston plate 30 and centering piston plate 30 with respect to transmission input shaft 82.

According to yet another example aspect, the method further comprises the step of installing seal 36 onto piloting sleeve 50, wherein circumferential wall 62 of piloting sleeve 50 includes external circumferential groove 56 that extends radially inward from first outer circumferential surface 68 and includes second outer circumferential surface 69 having second outer diameter OD2.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A piloting sleeve for a torque converter comprising:
an axis of rotation;
a tubular body portion including a circumferential wall comprising:
a first inner circumferential surface having a first inner diameter;
a second inner circumferential surface having a second inner diameter;
a first outer circumferential surface having a first outer diameter;
an extended portion including at least two castles, each including a tip portion, for attachment to a cover; and
a distal end.

2. The piloting sleeve of claim 1 where the at least two castles include:
an outer slant portion;
an inner slant portion; and
at least one side wall portion.

3. The piloting sleeve of claim 1 where the tip portion is flat, rounded, or pointed.

4. The piloting sleeve of claim 1 where the extended portion is formed by cold heading.

5. The piloting sleeve of claim 1 where the first inner diameter is at most equal to the second inner diameter.

6. The piloting sleeve of claim 5 where the second inner circumferential surface includes a recess portion for receiving a bushing.

7. The piloting sleeve of claim 1 having a circumferential groove that extends radially inward from the first outer circumferential surface and includes a second outer circumferential surface having a second outer diameter.

8. A torque converter comprising:
a cover;
the piloting sleeve of claim 7 fixedly attached to the cover;
a piston plate;
a seal disposed in the groove for sealing engagement with the piloting sleeve and the piston plate; and
a bushing for positioning a transmission input shaft.

9. The torque converter of claim 8 where the tip portion is flat, rounded, or pointed.

10. The torque converter of claim 8 where the extended portion is formed by cold heading.

11. The torque converter of claim 8 where the first inner diameter is at most equal to the second inner diameter.

12. The torque converter of claim 8 further comprising a cover pilot, wherein the second inner circumferential surface of the piloting sleeve includes a recess portion for receiving the bushing, and wherein an outer surface of the cover pilot is concentric relative to the recess portion.

13. The torque converter of claim 8 where the tip portions of the piloting sleeve are attached to the cover by projection welding.

14. A transmission assembly comprising:
a transmission input shaft; and
the torque converter of claim 8.

15. The transmission assembly of claim 14 where the transmission input shaft is centered by the piloting sleeve with respect to the cover.

16. The transmission assembly of claim 14 where a centering plate is fixedly attached to the piston plate and centers the piston plate with respect to the transmission input shaft.

17. A torque converter comprising:
a cover;
a piloting sleeve, fixedly attached to the cover, comprising:
a base tubular portion;
an extended portion including at least two castles, each having a tip portion; and
an external annular sealing groove;
a piston plate;
a seal disposed in the annular sealing groove for sealing engagement with the piloting sleeve and the piston plate; and
a bushing for positioning a transmission input shaft.

18. A method for installing a torque converter onto a transmission assembly comprising the steps of:
providing a piloting sleeve as in claim 1;
projection welding the tip portions of the piloting sleeve to a torque converter cover;
affixing a cover pilot having an outer surface to the cover;
machining the piloting sleeve and the cover pilot outer surface to be concentric with one another; and
pressing a bushing into the inner diameter of the tube for centering of a transmission input shaft.

19. The method of claim 18 further comprising the step of supporting and piloting the transmission input shaft with the bushing.

20. The method of claim 19 further comprising the step of fixedly attaching a centering plate to the piston plate and centering the piston plate with respect to the transmission input shaft.
